(19) United States
(12) Patent Application Publication
(10) Pub. No.: US 2002/0003177 A1
(43) Pub. Date: Jan. 10, 2002

(54) Electrostatic systems and methods for dispensing liquids

(76) Inventors: Stephen D. O'Connor, Pasadena, CA (US); Eugene Dantsker, Sierra Madre, CA (US); Ronald C. Gamble, Altadena, CA (US)

Correspondence Address: Rajiv Yadav, McCutchen, Doyle, Brown & Enersen, LLP, Three Embarcadero Center, 28th Floor, San Francisco, CA, 94111, US

(21) Appl. No.: 09/811,350

(22) Filed: Mar. 16, 2001

Related U.S. Application Data
(60) Provisional application No. 60/190,010, filed on Mar. 17, 2000.

(51) Int. Cl. B05B 5/025

(52) U.S. Cl. 239/696; 239/69

(57) ABSTRACT

In accordance with the present invention there is provided an apparatus for electrostatically dispensing small volumes of biological or chemical material from a dispensing tip or array of dispensing tips. The apparatus includes a voltage generator, a dispensing head containing the liquid to be dispensed, and an electrode that is in electrical communication with the liquid such that when a voltage pulse is applied to the electrode, the liquid is dispensed from the dispensing head onto a receptacle. The apparatus also can include an electrostatically charged counterplane and can include a guard shield. The invention also provides for means for movement of the dispensing apparatus and the receptacle relative to each other. The invention also provides methods for dispensing fluids onto a receptacle surface, including 96-, 384- and 1536-well plates.

### RELATED APPLICATION DATA

This application claims priority to provisional application Serial No. 60/190,010, filed Mar. 17, 2000, the entire disclosure of which is incorporated herein by reference

### FIELD OF THE INVENTION

The present invention relates generally to the dispensing of liquids and analysis of biological and chemical samples and, more particularly, to sample dispensing systems and techniques using electrostatic energy.

### BACKGROUND OF THE INVENTION

In the field of miniaturization and automation of chemical and biological experiments, one specific area of emphasis has been high throughput analysis using spatially addressed arrays.

These arrays are constructed by coupling a dispensing system to an XY position control system that positions the dispensing head over an area of interest. The arrays come in two general formats: well plates and surface arrays.

The biotechnology industry has adopted a number of standard well plate formats. The three most common are 96-, 384- and 1536-well plates. These well plates are available from a number of industry suppliers and in a number of materials for compatibility with certain classes of reagents. Reactions can be carried out in parallel by adding reagents to the wells of these plates with automated equipment. As the wells become more densely packed, and thus smaller in volume, dispensing technologies are needed to accurately and quickly add reagents or samples to these wells. A multiplexed format is preferred to speed the dispensing process.

Surface arrays are also used for certain biological and chemical studies. In this format, a planar surface is derivatized in a checker board format with different samples. Studies can then be performed on these arrays. Again, in a preferred format a dispensing technology is used that ca dispense very small quantities of sample in an accurate manner to form these arrays. Of particular interest is the use of such technology to create biological arrays on planar surfaces wherein known types of nucleic acid or protein are spatially addressed in a two dimensional fashion. Samples can then interact with the biological arrays and multiple assays can be performed simultaneously.

A number of different technologies have been used to produce small sample droplets, including capillary “quilling”, positive displacement jetting, thermal jetting, and piezojetting. All of these technologies have drawbacks and limitations.

Quilling technology is based on the concept that a tiny capillary tube is constructed and filled with the material to be dispensed. This quill is held about a planar substrate and brought into physical contact with the surface. The surface tension of the fluid, quill, substrate interface, the geometry of the quill, and the amount of time the quill is held in contact determine the size of the drop.

Positive displacement jetting comes in many forms and is the oldest method of droplet formation. Pumps and valves are used to produce displacement of fluid at a tip orifice.

Thermal and piezo jetting were pioneered in the printing industries. In thermal jetting, the orifice is heated very quickly to produce droplets. A piezojet works by squeezing a capillary tube that is connected to the orifice to spit out a drop.

These methods for dispensing liquids involve either a complicated valving system (for positive displacement, eg) or have an active jet head (either piezo jet, thermal jet, or capillary spotting). The former cannot make small drops. Also, the valve seals often get dissolved by the orgamc solvents. The physical mechanisms for the latter jets are inherently tied to the type of fluid to be dispensed and often don't work with organics. Additionally, the heads are usually expensive and thus are not disposable.

In providing for large arrays of small droplets or spots, a number of factors must be considered. The droplets should be reproducible in size, particularly if quantitative experiments are desired. Additionally, satellite droplets, which affect the size of the droplets in a sporadic fashion and may actually contaminate other spots if the arrays are being created in a fast manner, must be avoided. Finally, the device should be capable of being easily filled with samples and reagents, and easily cleaned to prevent contamination. Alternatively, the head should be disposable to alleviate cross contamination.

In view of the foregoing, there exists a need for low-cost, multiplexed dispensing system capable of producing small, reproducible droplets of biological and chemical materials.

### SUMMARY OF THE INVENTION

The present invention addresses the foregoing needs and provides additional advantages over existing dispensing technology. In this invention, electrostatic forces are used to dispense single droplets of materials from a dispensing tip forming an orifice, herein referred to as the “ElectroJet”. The ElectroJet approach of the present invention enables a low-cost, flexible dispensing system that is easily multiplexed to produce a system capable of accommodating many dispensing heads. The ElectroJet may be used to dispense biological material onto a planar array forrnat. Alternatively, the ElectroJet may be used to dispense biological material into the wells of a well plate. Alternatively, the ElectroJet may be used to dispense chemicals onto a planar substrate or into the wells of a well plate. Alternatively, the ElectroJet may be used to dispense single droplets of chemicals or biological molecules into a system for gas phase analysis, such as a mass spectrometer. Other applications of the ElectroJet may be utilized.

The present invention provides an electrostatic fluid dispensing device. This device consists of two basic parts: a dispensing tip forming a reservoir and an orifice and an electrostatic pulse generating device that is in electrical contact with the dispensing tip or reservoir. In one embodiment, the device is inexpensive to manufacture and is robust.

The dispensing tip can be of various sizes and made of various materials. The profile of the tip at the orifice can be of various dimensions, however a narrow taper with very thin side walls at the end is preferred. The dispensing tips can be readily multiplexed to form an array of dispensing tips.

In one embodiment, a delivery device of the present invention is capable of using very small amounts of liquid to dispense even smaller amounts in the form of droplets. In a preferred embodiment, the delivery device delivers a single droplet at a time.

Such a dispensing system can have a modular dispensing head, so that samples can be stored in a dispensing head and another dispensing head can be attached to the master manifold.

The invention also provides a dispensing system that is chemically compatible with or can accommodate the use of a vast array of liquid reagents or solutions including, but not limited to, organic solvents such as acetonitrile.

Another aspect of the invention is an electrostatic pulse-generating device. Generally, the pulse generated will be a high voltage (several hundred to a few thousand volts) low current (10 mA or less) waveform. Another object of the present invention is to create a switching and multiplexing system that allows a single voltage source to control many dispensing tips simultaneously or in a programmed fashion.

In a preferred embodiment, a dispensing system is constructed by bringing a dispensing tip orifice into proximity of a substrate, applying a voltage pulse to the fluid in said dispensing tip to produce sufficient electrostatic force to dispense a small droplet of fluid. The following parameters can be controlled to adjust the size of the droplets: orifice size, surface chemistry of the lower surface of the dispensing tip, size and shape of the voltage pulse, position of the counter-voltage relative to voltage pulse, geometry of system, including the presence of ground and voltage shields to better control the electric field in the vicinity of the droplet formation and trajectory. An additional parameter that can be controlled is the concentration of charge carrying moieties within the solution to be dispensing. In certain embodiments, these moieties are salt that is dissolved in the solution. In other embodiments, the charge carrying moieties can be the biological or chemical molecules that are to be dispensed. These parameters are by no means limiting.

### BRIEF DESCRIPTION OF THE DRAWINGS

FIG. 1 shows an electrostatic sample dispensing apparatus comprising a dispensing head with a dispensing tip with and without a counter electrode.

FIG. 2 shows a number of dispensing tip configurations.

FIG. 3 shows a dispensing head being scanned across a substrate to produce an array of sample drops.

FIG. 4 shows a multiple dispensing tip system which is adapted to move with respect to the sample receptacle. FIG. 4A shows four separate head multiplexed together and FIG. 4B shows a single head with four separate dispensing tips.

FIG. 5 shows a cross section of an electrostatic sample dispensing apparatus that can dispense sample liquid to a 96 well plate array. In the embodiment shown, the array is on a conveyor belt whereas the apparatus is stationary. FIG. 5A shows an apparatus with 96 separate head multiplexed together and FIG. 5B shows a single head with 96 separate dispensing tips.

FIG. 6 shows a 96 well plate dispensing apparatus where the electrode is a conducting material coated onto the dispensing surface.

FIG. 7 shows various electrode/counter electrode/ground configurations, including in FIGS. 7E and 7F, configurations with voltage shields.

### DETAILED DESCRIPTION OF THE PREFERRED EMBODIMENTS

In the present invention, electrostatic forces are used to dispense droplets of materials from a dispensing tip forming an orifice, hereinafter also referred to as the “ElectroJet”. The ElectroJet approach of the present invention enables a low-cost, flexible dispensing system that is easily multiplexed to produce a system containing many dispensing tips. The ElectroJet has many uses, including, without limitation, dispensing biological material onto a planar array format, dispensing biological material into the wells of a well plate, or dispensing chemicals onto a planar substrate or into the wells of a well plate.

The invention described herein provides a system to create and position micro-sized droplets on a surface or within wells on a substrate. The system can generate single droplets using electrostatic forces that are generated at the dispensing tip of the system. Generally, the fluid that is dispensed must be sufficiently conductive or polar to generate a charge differential at the surface of the fluid. Often, the fluid itself can generate this charge. Alternatively, a charge carrier (such as salt) may be present in the solution to generate this charge.

In one embodiment the invention is an electrostatic sample dispensing apparatus for dispensing analytical samples, which comprises a voltage generator which generates a dispensing voltage, a sample dispensing head; and a dispensing electrode in proximal relationship with the dispensing head such that when the sample dispensing head contains a sample liquid and when the dispensing electrode is fed with the dispensing voltage, at least a portion of the sample liquid is caused to be dispensed through the dispensing head onto a receptacle.

The material of interest may be dissolved in the solvent that is dispensed or suspended or dispersed in the solvent. Alternatively, it may comprise biological materials that are dissolved in a solution. These biological molecules may include nucleic acids, proteins, anti-bodies, peptides, sugars, lipids, etc. The material may be a chemical material that is dissolved or suspended in the solvent. Thus, electrostatic sample dispensing apparatus of the invention may be used with analytical samples that comprise a material selected from the group consisting of proteins, peptides, nucleic acids, oligonucleotides, tissue, chemical reagent, cellular materials and solvents. However, this list is not limiting—the invention can dispense a variety of liquids. Generally, the liquid must contain an electrolyte or be capable of carrying charge. However the amount of electrolyte present in the liquid need only be sufficient to create a charge concentration at the meniscus-to-air interface and generate a drop. That amount of free charge can be quite small, in some cases as small as the trace amounts of electrolyte present in nominally non-conducting liquids. In one embodiment of this invention, it is used to dispense drops of water. In another embodiment, this invention can be used to dispense drops of aqueous solutions of inorganic salts and buffers.

In another embodiment, this invention can be used to dispense drops of organic compounds including but not limited to ethanol, methanol, acetonitrile, dichloromethane, DMF, DMSO, pyridine, or any other organic solvent. In some cases, charge carriers must be added to the organic solvents in order to produce the charge differential at the surface of the fluid at the orifice. In one embodiment, large ionic radii inorganic salts, such as TBAPF6 may be used for this purpose.

The invention also provides for various methods of using the electrostatic dispensing apparatus of the invention. For example, in one embodiment, the invention is a method for dispensing a sample liquid into a microfluidic device, which method comprises using the electrostatic sample dispensing apparatus of the invention to dispense the sample liquid into the microfluidic device. In another embodiment, the invention is a method of analyzing biochemical samples using the electrostatic sample dispensing apparatus of the invention.

Significantly, the invention can be used to dispense individual drops of a liquid, a feature that is very useful in analytical processes. Thus, in an important embodiment, the invention also provides an electrostatic sample dispensing apparatus for dispensing a single drop of a liquid for use in an analytical process, which comprises a voltage generator which generates a DC voltage pulse, a sample dispensing head comprising a dispensing tip having an opening and a dispensing electrode in proximal relationship with the dispensing tip. The liquid may be a sample to be analyzed or it may be a biological probe. Such an electrostatic sample dispensing apparatus is used, for example, to dispense a single drop of a liquid for biochemical analysis of the drop. The biochemical analysis may be carried out using a gas phase analysis technique such as mass spectrometry. The analytical process, for example, may require that the drop of the liquid that is dispensed is dispensed onto a selected location within a spatially addressed array. In such an apparatus, the size of the drop of the sample liquid dispensed through the opening in the dispensing tip at each selected location is controlled by varying the size or shape of the DC voltage pulse. Preferably, the voltage pulse is a square-wave-type pulse and the height or width of the pulse may be varied to control drop size. In a preferred embodiment, such a sample dispensing apparatus is controlled through an interface with a computer.

As noted above, the invention can also be used to dispense drops of a biological probe onto an array. More particularly, the invention also provides an electrostatic dispensing apparatus for dispensing a single drop of a biological probe onto a selected location within a spatially addressed array, which comprises a voltage generator which generates a DC voltage pulse, a sample dispensing head comprising a dispensing tip having an opening, an XY-position control system whereby the dispensing head is manipulated to a position above the selected location within the array, and a dispensing electrode that is in proximal relationship with the dispensing port such that when the sample dispensing head contains the biological probe and when the dispensing electrode is fed with the DC voltage pulse, a drop of the biological probe dispensed through the opening in the dispensing tip onto the spatially addressed array at the selected location.

In a preferred embodiment, the dispensing head of the invention further comprises a dispensing tip having an opening. The dispensing tip can be of various sizes and made of various materials. The profile of the tip at the orifice can be of various dimensions, however a narrow taper with very thin side walls at the end is preferred. The dispensing tips can be readily multiplexed to form an array of dispensing tips. Applying a voltage pulse to the fluid in the dispensing tip produces sufficient electrostatic force to dispense a small droplet of the fluid. The following parameters can be controlled to adjust the size of the droplets: orifice size, surface chemistry of the lower surface of the dispensing tip, size and shape of the voltage pulse, position of the counter-voltage relative to voltage pulse, static or dynamic pressure on the liquid in the reservoir, geometry of system, including the presence of ground and voltage shields to better control the electric field in the vicinity of the droplet formation and trajectory. These parameters are by no means limiting.

In another embodiment, the dispensing head is constructed from a single substrate such as a silicon wafer. A larger well is etched on one side of a wafer and a smaller through hole is etched inside of the larger well, so that it goes all the way through the wafer substrate to the opposite side. Electrical connections can be made through sputtering, or electrodes can be manually added. Fluid can be added to the larger wells on the back-side of the device and the small through-orifices can be used for the Ejetting. This type of dispensing head can also be made with an array of dispensing orifices and wells. Other construction techniques are also possible

The dispensing apparatus of the invention can have a modular dispensing head, so that samples can be stored in a dispensing head and another dispensing head can be attached to the master manifold.

In a preferred embodiment, the electrostatic sample dispensing apparatus of the invention may further comprise a coupling flowably connecting the dispensing head to a suction device that can create a vacuum in the dispensing head whereby the sample liquid to be dispensed can be aspirated into the dispensing head. Thus, when the dispensing head is dipped into a solution of material to be dispensed, negative pressure is used to aspirate a small amount of the solution up into the dispensing orifice, the head is then positioned over the area where dispensing is to occur, then the voltage pulse is applied to dispense a small droplet. The orifice can be repositioned and additional droplets dispensed. In this manner, droplets can be formed from a very small sample of material.

The dispensing head can also use capillary action to suck in the liquid to be dispensed.

This is particularly the case when the dispensing head also comprises a dispensing tip that is a capillary. If the dispensing tip is a capillary, the sample liquid will flow into the dispensing tip (and head) by capillary action when the dispensing tip is placed in a container of the sample liquid.

The invention also provides a dispensing system that is chemically compatible with or can accommodate the use of a vast array of liquid reagents or solutions including, but not limited to, organic solvents such as acetonitrile.

The voltage generator of the invention is an electrostatic pulse generating device. Generally, the pulse generated will be a high voltage (several hundred to a few thousand volts) low current (10 mA or less) waveform. The voltage generator may also be associated with a switching and multiplexing system that allows a single voltage source to control multiple dispensing tips simultaneously or in a programmed fashion. Preferably, a direct current (DC) voltage pulse is used. Thus, in a preferred embodiment, the electrostatic sample dispensing apparatus of the invention is such that the dispensing voltage is a DC voltage pulse.

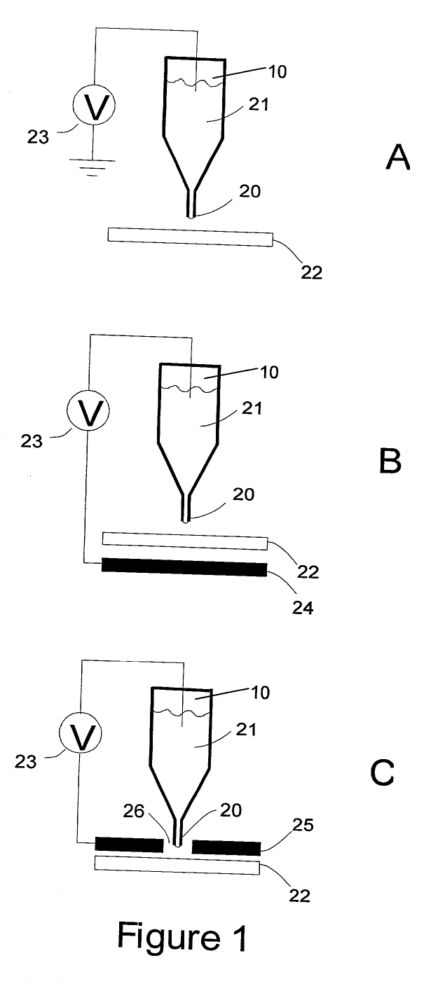

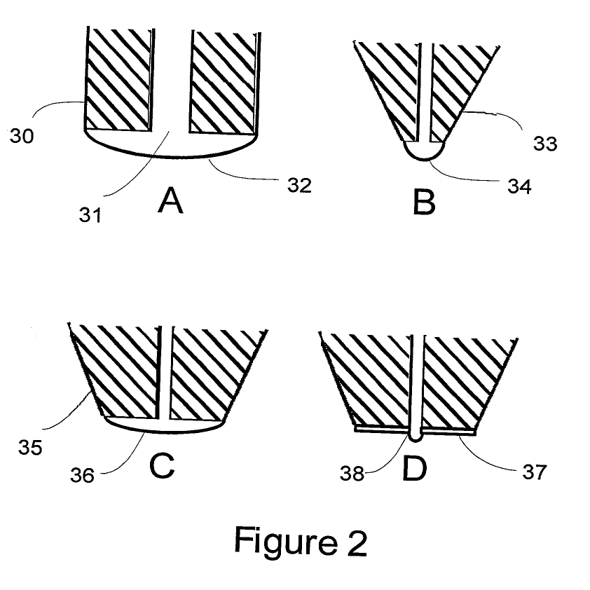

Referring to FIG. 1A, the device consists of a dispensing tip (20) filled with liquid (21) and a receptacle (22) directly beneath. The liquid is under sufficient hydrostatic pressure to prime the line, but not sufficient to overcome the surface tension forces of the meniscus at the bottom of the tip, and therefore liquid normally does not flow. This meta-stable state is disrupted when a voltage pulse is generated by the voltage generator (23) and applied to the liquid within the dispensing head causing a charge differential to occur at the liquid-to-air interface. The electrostatic field creates a momentary instability and tears off a drop from the tip. The drops are projected onto the receptacle (22). In one embodiment, the receptacle (22) is left floating, implying that the voltage differential is applied between the fluid in the orifice and true ground. Alternatively, the receptacle (22) may be grounded.

In another embodiment, the electrostatic sample dispensing apparatus of the invention may also include a counter electrode arranged opposite to the dispensing tip and having a necessary potential for electric attraction of charged sample liquid dispensed through the opening in the dispensing tip. In one embodiment, the counter electrode defines an opening through which the sample liquid can be dispensed onto the receptacle. In that case, the counter electrode can be located between the dispensing tip and the receptacle. . Referring to FIG. 1B, a conductive counter electrode (24) is placed below the receptacle (22) and the voltage pulse is applied between the counter electrode (24) and the fluid (21). Alternatively, the conductive counter electrode (25) is held above the receptacle. A hole (26) is created in the counter electrode so that the droplet can be emitted from the opening in the dispensing tip (20) and strike the receptacle (22). In this embodiment, the electric field lines extend out from the opening in the dispensing tip laterally. The field lines are sufficiently symmetric as they extend out to dispense the droplet vertically towards the receptacle.

Insulating materials (such as glass or solid plastic) are commonly used for substrates in biological and chemical analysis but such materials present special problems in sample dispensing. When the dispensing tip is placed over an insulating material and the ground plane is positioned behind the receptacle (or no ground plane is used), the high voltage pulse successfully dispenses an initial droplet. However, it is difficult to dispense a second droplet onto said receptacle at nearby locations. It has been discovered herein that to dispense multiple drops at the same location or at nearby locations, one technique is to reverse the polarity of the voltage pulse after a single droplet is formed onto a receptacle. A second droplet can then be formed onto said substrate. This procedure can be repeated to dispense additional droplets.

Therefore, in a preferred embodiment, the invention provides for dispensing drops of a liquid sample onto an insulating substrate such as glass, which is commonly used for biochemical analysis. Thus, the invention provides an electrostatic dispensing apparatus for dispensing a liquid onto a substrate comprised of an insulating material, which comprises a voltage generator which generates a DC voltage pulse, a dispensing head comprising a dispensing tip having an opening and a dispensing electrode in proximal relationship with the dispensing tip such that when the dispensing head contains a liquid and when the dispensing electrode is fed with the DC voltage pulse, a drop of the liquid is caused to be dispensed through the opening in the dispensing tip onto the insulating substrate. This embodiment may further comprise a control system for controlling the size, shape and polarity of the DC voltage pulse. This embodiment may be used to dispense multiple drops by reversing the polarity of the voltage pulse after each drop of the liquid is dispensed. In another embodiment, after a drop is dispensed, the receptacle is momentarily grounded to dissipate the accumulated charge before the next drop is dispensed. Alternatively, the counter electrode is positioned between the receptacle and the orifice. A hole is placed in the counter electrode so that the droplet formed can fly through the counter electrode and strike the receptacle. In this manner, many droplets can be formed onto an insulating receptacle.

The dispensing tip can be a hollow tube, for example a capillary tube, of small inner diameter. In a preferred embodiment, both the inner and the outer diameter of the tip taper between the inlet end and the dispenser end of the tip. Since the dimensions of the tip affect the drop size, a tip opening of very small inner diameter is preferred when small droplets are desired. In a preferred embodiment, the inner diameter of the dispenser end of the tip is 0.0005″ to 0.10″, with 0.0005″ to 0.02″ being more preferred and 0.0005″ to 0.01″ being most preferred. Referring to FIG. 2, a number of possible tip constructions are shown. Referring to FIG. 2A, a tip is formed from a straight capillary with thick walls (30) relative to the orifice (31) formed in the tip. The fluid front (32) at the orifice can become over-primed. The production of droplets in this embodiment is generally not reproducible. In a more preferred embodiment, the walls of the dispensing tip taper. Referring to FIG. 2B, the walls of the dispensing tip (33) taper down at the orifice. In this embodiment, the priming (34) at the orifice is more constrained and generally produces a more reliable and reproducible droplet. In an even more preferred embodiment the walls of the dispensing tip at the orifice are thinner than the diameter of the orifice itself. This embodiment minimizes the spreading of the fluid front, as shown in FIG. 2A.

The tip, which may be a capillary, can be constructed from a number of materials including glass, metal, plastics and ceramics. Methods of making capillary tubes of small inner cross-section are known to those skilled in the art.

The surface chemistry of the electrostatic dispensing head of the invention is adjusted to control the shape of the liquid meniscus that forms at the opening in the dispensing tip. The dispenser tips can be chemically treated on the inner surface, the lower surface, the outer surface or on all surfaces. The coating can be hydrophobic, hydrophilic, or other types of coatings. In a preferred embodiment, where a water-based solution is used, the outside surface of the tip is hydrophobic to prevent the liquid from flowing up along the outer surface.

Referring to FIG. 2C, a tapered dispensing tip (35) is shown where the surface characteristic of the lower surface of the dispensing tip at the orifice promotes sheeting (36) of the fluid to be dispensed. A preferred embodiment is shown if FIG. 2D, where the surface chemistry of the lower surface of the dispensing tip at the orifice (37) is adjusted to cause the sample to bead (38), rather than sheet. The inventors have found that careful control of the surface chemistry of the dispensing tips has a great effect on the production of single droplets a and on the reproducibility of those droplets.

Some commercially available components can be used as dispenser tips. In a preferred embodiment, the tip is a commercially available plastic pipette tip. These tips can be mounted onto existing automated pipettors in order to retrofit existing equipment with the ElectroJet. In another preferred embodiment, ceramic capillary tips for ball wire-bonding (Micro Swiss, Willow Grove, Pa.) taper from a typical inner diameter of 0.060″ to a typical inner diameter of 0.0008″ to 0.020″ and therefore can be used. Alternatively, hollow, thin-walled metal needles can be used as dispenser tips.

Electrical contact to the liquid is made in a number of ways. In a preferred embodiment, a metal electrode is placed within the fluidic network above the opening of the tip. In another embodiment, the electrode is a metal tube that is part of the network. In another embodiment, the electrode is a thin wire inserted into one of the tubes of the network or into the tip. In another embodiment, the tip is made from a conducting material and used as the electrode. In another embodiment, the tip or another part of the fluidic network is coated with a metal film and used as the electrode.

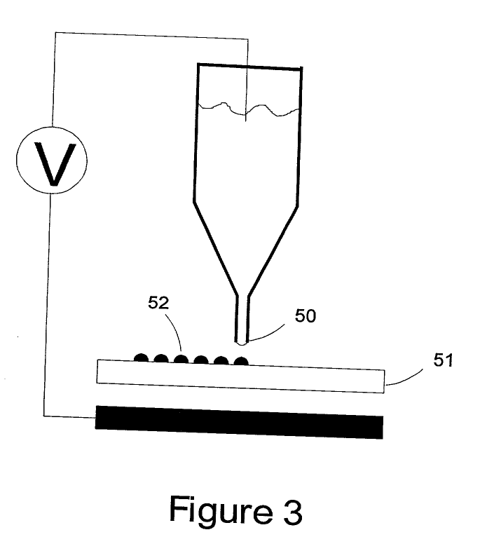

Referring to FIG. 3, a head with a single dispensing tip (50) is scanned across a single substrate (51) to produce a linear array of droplets (52). Thus, in another embodiment, the invention provides an electrostatic sample dispensing apparatus for dispensing drops of a sample liquid into a spatially addressed array, which comprises a voltage generator which generates a DC voltage pulse, a sample dispensing head that comprises a dispensing tip that has an opening, an XY-position control system which is used to manipulate the dispensing head to a position above a selected location within the array and a dispensing electrode in proximal relationship with the dispensing tip such that when the sample dispensing head contains a sample liquid and when the dispensing electrode is fed with the DC voltage pulse, drops of the sample liquid are dispensed through the opening in the dispensing tip onto the spatially addressed array at the selected location. In various forms of this embodiment, the spatially addressed array comprises a surface array or it comprises an array of well-plates. In another version of this embodiment, the apparatus further comprises a counter electrode arranged opposite to the dispensing tip that has a necessary potential for electric attraction of charged drops of the sample liquid dispensed through the opening in the dispensing tip. The counter electrode, in an alternative embodiment, defines an opening through which drops of the sample liquid can be dispensed onto the spatially addressed array. In yet another embodiment, the counter electrode is located between the dispensing tip and the spatially addressed array.

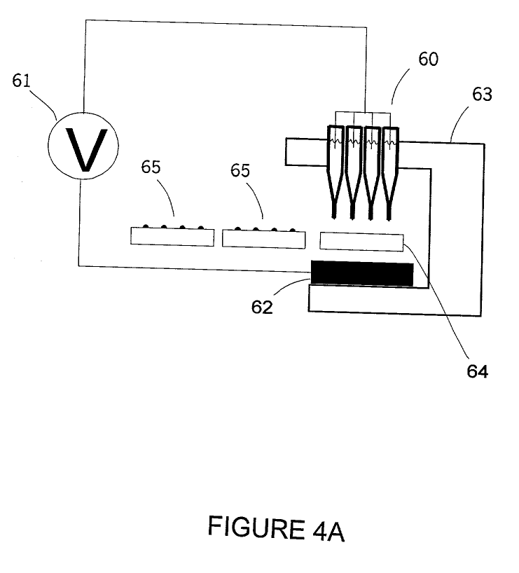

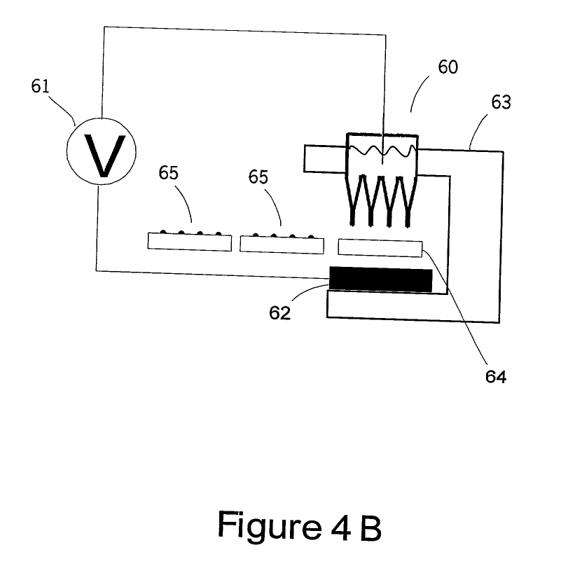

As described below in greater detail with reference to FIGS. 4-6, also contemplated by the invention are embodiments that can be used to dispense single drops of the same liquid simultaneously over multiple locations, or embodiments that contain multiple dispensing heads or tips each adapted to contain a different type of liquid, which can then be dispensed simultaneously over multiple locations or sequentially over a single location. Thus, the invention also provides an electrostatic sample dispensing apparatus which has a dispensing head that comprises a plurality of dispensing tips, each tip having an opening. Alternatively, the electrostatic sample dispensing apparatus of the invention comprises a plurality of sample dispensing heads. In this embodiment, the electrostatic sample dispensing apparatus is such that one dispensing head contains a first sample liquid and at least one other dispensing head contains a second sample liquid. In another preferred embodiment, an array of dispensing tips is bundled together in a single head. Each of the dispensing tips can carry the same fluid, or a different fluid.

Referring to FIG. 4, four dispensing tips (60) are arrayed together and controlled by a single voltage generating device (61). The array (60) is connected to a voltage counter electrode (62) with a mount (63). Generally, this mount will be non-conductive or semi-conductive. The mount (63) can be mounted onto an XY control position device in order to position the dispensing head (60) above a receptacle (64). Once an array of droplets is formed (65), the head and counter electrode can be repositioned over a new receptacle.

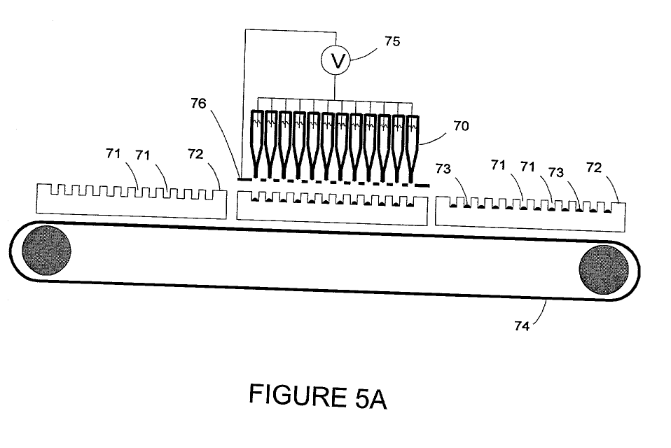

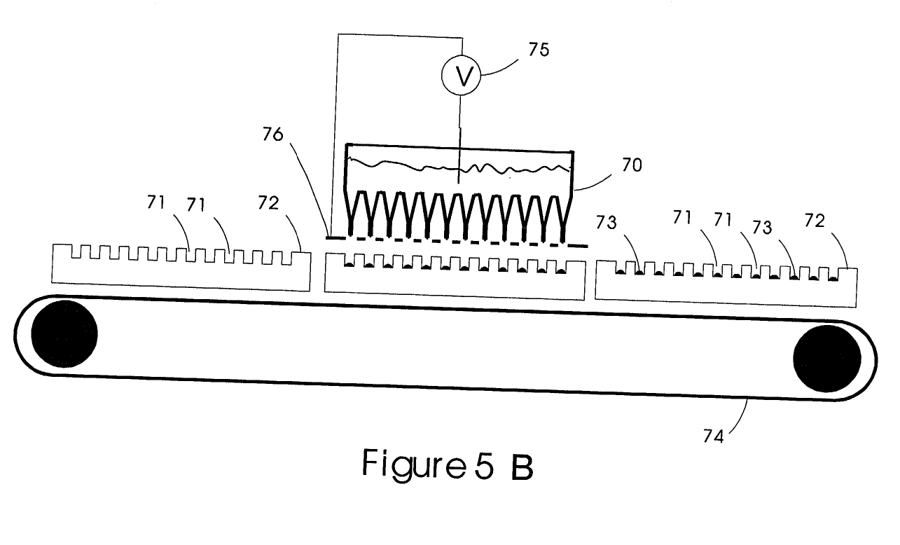

In a preferred embodiment, an array of dispensing tips is constructed and laid out in a format that is consistent with standard biological equipment. Referring to FIG. 5, an array of jetting dispensing tips is laid out in a 96-well plate format. This figure shows a cross section of the device. Ninety-six dispensing tips, twelve are shown (70), are arrayed in such a manner that a tip is placed above each of the wells (71) of a 96-well plate (72). Each dispensing tip is filled with a material to be placed into the individual wells of the plates. The material can be the same reagent or sample or different reagents or samples. A plate is placed under the dispensing array, the voltage is pulsed, and a droplet forms in each well (73). A new plate is then moved under the jetting array, or the array is moved over a new plate. In a certain embodiment, this is accomplished by placing plates on a conveyor belt (74). Alternatively, the entire system can be built onto an XY position control system. In the embodiment shown, the voltage source (75) applies a voltage pulse between the fluid and a counter electrode grid (76). This grid is a conductive sheet that has 96 holes co-located with the orifices of the dispensing tips. Alternatively, other voltage configurations are possible.

In one embodiment, this device can dispense drops from multiple dispensing tips supplied by a manifold from a common liquid reservoir. The tips can dispense drops simultaneously or in a pre-programmed sequence. In another embodiment, the invention can dispense drops from multiple tips supplied by different liquid reservoirs, either simultaneously or in a sequence.

Liquid is supplied to the dispensing head via a fluidic network that contains a reservoir, a conduit that carries the liquid to the head, and a means of regulating the pressure of the liquid. The fluidic network can be a monolithic conduit or can consist of parts joined together with plumbing-type connectors. The head can be a physical part of the network or can be a separate component whose inlet end is connected to the conduit. Alternatively, liquid can be aspirated into the tip through the dispenser end rather than through a back-end fluidic network. This embodiment is of value when small amounts of liquid are available.

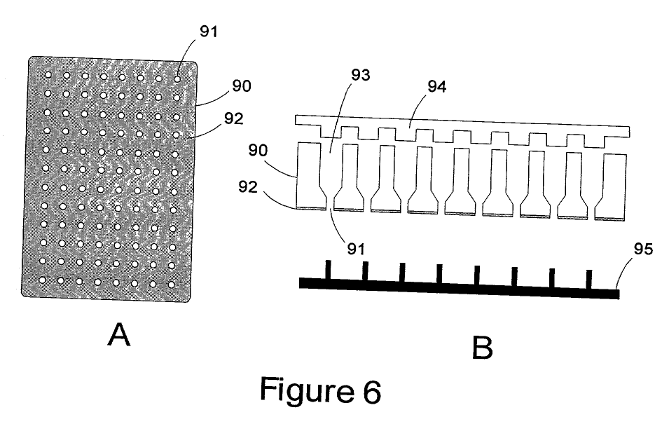

In a preferred embodiment, the fluids to be dispensed are stored in the dispensing head. A cap or cover can be placed onto the dispensing head or array to keep the fluid of interest from evaporating or degrading. In a preferred embodiment, a dispensing head is constructed with a similar layout as a 96-, 384-, or 1532-well plate. Referring to FIG. 6, two 96-well plate dispensing heads are shown. Referring to FIG. 6A, a bottom view of a dispensing head fabricated from a single substrate, such as a silicon wafer, is shown (90). The well plate in this case has been constructed so that the wells actually have small orifices 91 in the bottom of the structure for dispensing the liquid. Additionally, in this embodiment, the bottom surface of the well plate is coated with a conducting material 92, such as evaporated aluminum or gold. In this manner, connection to the fluid for voltage creation is straightforward. Alternatively, an electrode manifold could be constructed to insert 96 platinum or other conducting electrodes into the tips when used. FIG. 6B is a schematic of a side view of the device. The tips (93) are shown, as are the orifices (91) and the conductive coating (92). Also shown are a cover plate for the top of the head (94) and for the bottom of the head (95). The well plate dispensing head can be capped with these or other covers for storage. In a preferred embodiment, samples are loaded into the well plate dispensing heads shown here and stored within the dispensing heads.

An important aspect of the invention is that the size of the drops can be adjusted by regulating the static pressure at the opening in the dispensing tip. The size of a droplet that is formed is dependant on both the size of the meniscus at the opening and the shape of the voltage waveform that is applied. Both characteristics can be controlled. Static pressure can be regulated hydrostatically by varying the height of the liquid reservoir above the level of the tip. Alternatively, pressure can be regulated by adjusting the temperature of a volume of gas contained within a hermetically sealed fluidic network. As the temperature is raised, the vapor pressure of the gas increases thereby increasing the pressure of the liquid. Alternatively, pressure is regulated by adjusting the position of a plunger in contact with the liquid reservoir.

Thus, for each of the many different embodiments described supra, the electrostatic sample dispensing apparatus of the invention also comprises pressure control means for controlling the pressure of the sample liquid contained in the dispensing tip. The pressure control means comprise, for example, a sample liquid reservoir in fluid communication with the dispensing head whereby the static head of the sample liquid in the dispensing tip can be changed. In a preferred embodiment, a mechanism of active feedback is used to accurately regulate the static pressure of the liquid in the dispensing tip. A pressure sensor, for example a MEMS piezoelectric pressure sensing device, that reads the pressure of the liquid supplies control signals to a pressure regulator such as a motor or heater.

In a preferred embodiment of the present invention, the size of the droplets that are dispensed from a dispensing tip or an array of tips can be rapidly changed while the dispensing head is being moved by simply adjusting the pressure on the reservoirs or size and shape of the voltage pulse. In this manner, very rapid changes in the volume to be dispensed can be made by simply changing the output from a computer program or other software means. For example, software can be programmed to dispense a variety of volumes over a spatial area. The program can output a signal to a control circuit that can rapidly change the back pressure on the system, and/or the shape of the voltage pulse. Thus, each of the embodiments of the electrostatic sample dispensing apparatus of the invention may further comprise a control system for controlling the amount of the sample liquid dispensed through the opening in the dispensing tip. In various embodiments, the amount of the sample liquid dispensed through the opening in the dispensing tip is controlled by varying the size of the DC voltage pulse or the shape of the DC voltage pulse. The control system preferably comprises computerized solid state circuitry.

The configuration of the ground relative to the voltage pulse applied can be varied. In certain embodiments, the ground is left floating (see FIG. 1A). In another preferred embodiment, a ground plane (24) or point is placed behind the receptacle substrate (see FIG. 1B). In yet another embodiment, the ground plane (24) is placed between the opening in the dispensing tip and the receptacle. A hole (25) may be placed in the ground plane in order to allow the droplet to pass through onto the substrate (see FIG. 1C). In another embodiment, the receptacle itself is the ground plane. In another embodiment, no ground plane is used and the voltage is applied versus true ground.

The counter electrode may be a conducting or semi-conducting surface. In one embodiment, the counter electrode is a substantially planar metal plate. In another embodiment the counter electrode is curved or shaped. In one embodiment the counter electrode is a metal film deposited onto an insulating substrate. In an alternate embodiment, the counter electrode is one or more localized metal tips directly beneath the opening of the dispenser tip.

Surprisingly, it has been found that guard shields are often required for the device to perform properly, especially when insulating receptacles are used and the ground plane is behind the receptacle or no ground plane is present. When an insulating receptacle is used and the counter electrode is located behind the receptacle, the electric field between the orifice and counter electrode can become distorted if any other stray grounds are present. Thus, a shielding system may be necessary to avoid this distortion.

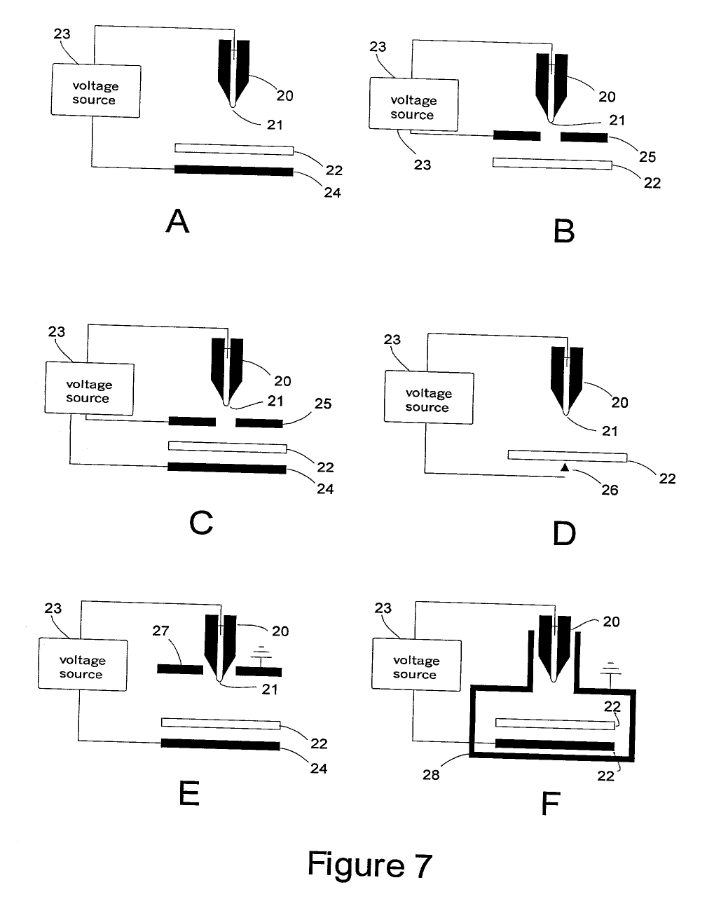

As discussed below with reference to FIG. 7, the electrostatic sample dispensing apparatus of the invention may be used in various ways. For example, the invention also contemplates a method of dispensing an analytical sample liquid using the electrostatic dispensing apparatus of the invention, which method comprises placing the analytical sample liquid into the dispensing head, electrically connecting the voltage generator to the dispensing electrode and the counter electrode, and using the voltage generator to create an electrical potential difference between the analytical sample liquid and the counter electrode. The electrical potential difference between the analytical sample liquid and the counter electrode is at least 500 volts, more preferably at least 2000 volts and most preferably is at least 4000 volts. In various embodiments, the electrical potential difference between the analytical sample liquid and the counter electrode is created by applying a voltage pulse to the dispensing electrode while maintaining a voltage bias between the counter electrode and the ground, or by applying a voltage pulse to the dispensing electrode and holding the counter electrode at ground potential, or by applying a voltage pulse to the counter electrode while holding the dispensing electrode at ground potential, or by applying a voltage pulse to the dispensing electrode while maintaining an electrical potential difference between the counter electrode and the ground.

Referring to FIG. 7, a number of voltage/counter-plane/ground configurations are shown. In one embodiment shown in FIG. 7A, the voltage is applied between the fluid (21) and a counter electrode (24) located behind the receptacle. Referring to FIG. 7B, in another embodiment, the counter electrode (25) is held between the dispensing tip (20) orifice and the receptacle (22). The counter electrode (25) contains an orifice that is positioned between the opening in the dispensing tip and receptacle so that the droplet formed can pass through and strike the receptacle.

In certain embodiments, a complicated waveform may be used so that the droplet may be controlled while in its flight path. Referring to FIG. 7C, two counter-planes are used. In this embodiment, more complicated waveforms can be used to affect the droplets or control the flight path of the droplet. In one embodiment, a voltage is applied between the fluid (21) and the counter electrode (25) that contains the orifice. Once a droplet is formed, the voltage source then applies a subsequent force to the second counter electrode (24). In one embodiment, the second voltage is applied between the two counter-planes to accelerate the droplets towards the receptacle. Other voltage forms are possible. It is also possible to ground one (or both) of the counter electrode while the voltage pulse is applied.

In another embodiment, a different type of counter electrode is used. Referring to FIG. 7D, a point source counter electrode (26) is used. Alternative arrangements can include circular counter-planes, arrayed counter-planes, linear counter-planes, and the like. These alternative configurations can have an effect on the electric field lines that are generated by the voltage pulse and thus an effect on the formation and flight path of the droplet. An optimal configuration can be determined for a given set of parameters.

A ground type surface can be used to shield the jetting area from its surroundings and any stray or additional electric fields and, therefore, in one embodiment, the electrostatic sample dispensing apparatus of the invention also comprises a voltage shield in proximal relationship with the dispensing tip.. Referring to FIG. 7E, a ground plate (voltage shield) (27) is used to shield the jetting area. FIG. 7E shows the ground plate as grounded but the ground plate can also have a positive or negative voltage applied during the jetting. Thus, the voltage shield may be maintained at ground potential. Alternatively, a potential difference is maintained between the voltage shield and the ground. In FIG. 7E, the plate has holes placed within it so that the orifice can extend past the plate. Referring to FIG. 7F, a ground system (28) that surrounds the dispensing apparatus can be added to protect the jetting region.

These voltage surface arrangements can be combined and multiplexed. More than one dispensing tip can be used. The voltages on the dispensing tips can be fired simultaneously or controlled in a serial fashion. The ground planes can be connected to ground or to other voltages through the voltage source system. The ground planes may be held at a static voltage or pulsed. The receptacle itself can be a conductor that acts as the counter-plane, or as a shield, or floats.

One skilled in the art will see that many physical and electrical configurations are possible.

To dispense drops, the voltage pulse between the liquid and the counter electrode is at least 500 V, with at least 2 kV being more preferred and at least 4 kV being most preferred. Numerous configurations are possible to attain these potential differences. In one embodiment, the liquid is pulsed to a positive high voltage while the counter electrode is biased at a voltage of same magnitude but opposite (negative) polarity with respect to ground. For example, the liquid is pulsed to +2 kV with respect to ground while the counter electrode is held at a bias of −2 kV with respect to ground for a pulse of 4 kV voltage difference. In another embodiment, the liquid 10 is pulsed to a negative high voltage while the counter electrode is biased at a voltage of same magnitude but opposite (positive) polarity. In another embodiment, the liquid is pulsed at a high voltage while the counter electrode is held at a voltage of different magnitude. Specifically, the counter electrode can be held at ground potential while the liquid is pulsed to a positive or negative high voltage with respect to ground. In another embodiment, both the liquid and the counter electrode are pulsed simultaneously. For example, both the liquid and the counter electrode are initially at ground (0 V) potential; to dispense a drop, the liquid is pulsed to +2 kV while the counter electrode is pulsed to −2 kV before being brought back to ground (0 V). The two pulses may be synchronized or there may be a phase or time delay. In another embodiment, only the counter electrode is pulsed to a high positive or negative voltage while the liquid is held at ground. In another embodiment, the liquid is biased at a high voltage while the counter electrode is pulsed to a high voltage of opposite polarity. This embodiment is less preferred since the high voltage bias can create electrolysis in a water-based liquid, creating gas bubbles that can adversely affect the dispensing. In a more preferred embodiment, the liquid is either permanently at ground or is momentarily pulsed.

In a preferred embodiment, one of the objects is held at a high voltage, for example the counter-plane. This voltage is not sufficient to produce droplet formation or electro-spray. In order to form a droplet, the other object, for example the fluid in the dispensing tip, is pulsed. In this manner, smaller voltages may be used and solid state switching system can be constructed. In a preferred embodiment, the counter electrode is held at +2 kV and the fluid is pulsed at −700 V, producing a pulse differential of 2700 V, which in certain embodiments is sufficient for droplet formation. In this embodiment, a simple high voltage transistor can be used to apply the 700 V pulsed. In this embodiment, the gate of the transistor can be controlled by a 5 V TTL pulse. Thus, the system may be controlled by a computer or other standard integrated circuit.

The shape of the voltage pulse can be varied, which means that both the height and the width of the voltage pulse can be varied. The width of the voltage pulse is determined by the time of the pulse, which can range from less than microseconds to minutes but preferably ranges from less than one microsecond to seconds. In certain embodiments, the voltage pulse is a square wave type pulse. The width of this pulse can be varied, but must be sufficiently wide to allow a charge differential to be created at the surface. The droplet is then formed and dispensed onto the receptacle to relieve some or all of this charge differential. However, the width of the voltage pulse must be sufficiently short to avoid the creation of an electro-spray where more than one droplet is formed.

In certain embodiments, electronics can be constructed that allow one or more of the jetting dispensing tips to be fired simultaneously. In certain embodiments, the electronics will be controlled by a computer or other processor in order to produce droplets in a specified sequence. These electronics can be automated or controlled by a user. In certain embodiments, the control will be through software.

The receptacle can be any number of materials, and may depend on the nature of the material to be dispensed. In a preferred embodiment, the receptacle is substantially planar. The receptacle can be constructed out of any number of conducting, semi-conducting or non-conducting materials, including but not limited to glass, plastic, metal, ceramics, paper, etc. In one embodiment, a conducting receptacle surface also can serve as the counter-plane. In certain embodiments, the receptacle may be chemically reactive or physically active so that the droplet or material within the droplet becomes non-diffusely bound to the surface. Examples of binding include electrostatic attraction, covalent bonding or the like. The surface may be pre-treated to initiate this binding, if necessary.

In another embodiment, the surface is chemically inert and does not react with the sample in any manner. In another embodiment, the receptacle is substantially non-planar. In a preferred embodiment, the receptacle is a container. In a more preferred embodiment, the receptacle container is part of an array such as a standard 96-hole plate. In this embodiment, the counter electrode can be a metal film deposited onto the lower surface of the receptacle container.

In another embodiment of this invention, the receptacle surface is coated with a chemical. The chemical treatment of the substrate may serve to bind a chemical or biological receptacle that is present in the droplets. Examples include coating the surface with an antibody material or charged moiety such as poly-lysine.

The described systems may be used in various ways to produce arrays, dispense samples and reagents, or the like. The solutions may contain a variety of components, including compounds, oligomers, including oligonucleotides, polymers, and solvents. The described system can be used to synthesize compounds. In this manner, combinatorial synthesis can be enabled. The described system may be used to screen molecules and libraries of compounds. In a preferred embodiment, the system is used for screening of ligand-receptor biding, hybridization of complementary nucleic acids, agonist or antagonist activity, or a physical characteristic such as fluorescence, luminescence, absorption, etc.

It is to be appreciated that the foregoing description of the invention has been presented for purposes of illustration and explanation and is not intended to limit the invention to the precise manner of practice herein. Therefore, changes may be made by those skilled in the art without departing from the spirit of the invention and that the scope of the invention should be interpreted with respect to the following claims.

What is claimed is:

1. An electrostatic sample dispensing apparatus for dispensing analytical samples, the electrostatic sample dispensing apparatus comprising:
a voltage generator which generates a dispensing voltage;
a sample dispensing head; and
a dispensing electrode in proximal relationship with said sample liquid such that when said sample dispensing head contains a sample liquid and when said dispensing electrode is fed with said dispensing voltage, at least a portion of the sample liquid is caused to be dispensed through said dispensing head onto a receptacle.

2. The electrostatic sample dispensing apparatus of claim 1 wherein the dispensing head firther comprises a dispensing tip having an opening.

3. The electrostatic sample dispensing apparatus of claim 2 wherein the dispensing tip is so adapted that when the dispensing tip is placed in a container of the sample liquid, the sample liquid flows into the dispensing tip by capillary action.

4. The electrostatic sample dispensing apparatus of claim 1 wherein the dispensing head further comprises a plurality of dispensing tips, each tip having an opening.

5. The electrostatic sample dispensing apparatus of claim 1 further comprising a plurality of sample dispensing heads.

6. The electrostatic sample dispensing apparatus of claim 5 wherein one dispensing head contains a first sample liquid and at least one other dispensing head contains a second sample liquid.

7. The electrostatic sample dispensing apparatus of claim 1 further comprising a coupling flowably connecting the dispensing head to a suction device that can create a vacuum in the dispensing head whereby the sample liquid to be dispensed can be aspirated into the dispensing head.

8. The electrostatic sample dispensing apparatus of claim 1 wherein the dispensing voltage is a DC voltage pulse.

9. The electrostatic sample dispensing apparatus of claim 4 further comprising:
a voltage shield in proximal relationship with said dispensing tip.

10. The electrostatic sample dispensing apparatus of claim 9 wherein the voltage shield is maintained at ground potential.

11. The electrostatic sample dispensing apparatus of claim 9 further comprising means for maintaining a potential difference between the voltage shield and the ground.

12. The electrostatic sample dispensing apparatus of claim 4 further comprising:
a counter electrode arranged opposite to said dispensing tip and having a necessary potential for electric attraction of charged sample liquid dispensed through the opening in said dispensing tip.

13. The electrostatic sample dispensing apparatus of claim 12 wherein the counter electrode defines an opening through which the sample liquid can be dispensed onto the receptacle.

14. The electrostatic sample dispensing apparatus of claim 13 wherein the counter electrode is located between the dispensing tip and the receptacle.

15. The electrostatic sample dispensing apparatus of claim 4 wherein the surface chemistry of the dispensing head is adjusted to control the shape of the liquid meniscus that forms at the opening in the dispensing tip.

16. The electrostatic sample dispensing apparatus of claim 4 further comprising pressure control means for controlling the pressure of the sample liquid contained in the dispensing tip.

17. The electrostatic sample dispensing apparatus of claim 16 wherein the pressure control means comprise a sample liquid reservoir in fluid communication with the dispensing head.

18. The electrostatic sample dispensing apparatus of claim 8 further comprising:
a control system for controlling the amount of said sample liquid dispensed through the opening in said dispensing tip.

19. The electrostatic sample dispensing apparatus of claim 18 wherein the amount of said sample liquid dispensed through the opening in said dispensing tip is controlled by varying the size of the DC voltage pulse or the shape of the DC voltage pulse.

20. The electrostatic sample dispensing apparatus of claim 18 wherein the control system comprises computerized solid state circuitry.

21. The electrostatic sample dispensing apparatus of claim 20 wherein the analytical sample comprises a material selected from the group consisting of proteins, peptides, nucleic acids, oligonucleotides, tissue, chemical reagent, cellular materials and solvents.

22. A method for dispensing a sample liquid into a microfluidic device, the method comprising using the electrostatic sample dispensing apparatus of claim 1 to dispense said sample liquid into said microfluidic device.

23. An electrostatic sample dispensing apparatus for dispensing drops of a sample liquid into a spatially addressed array, said electrostatic sample dispensing apparatus comprising:
a voltage generator which generates a DC voltage pulse;
a sample dispensing head comprising a dispensing tip having an opening;
an XY-position control system whereby the dispensing head is manipulated to a position above a selected location within said array; and
a dispensing electrode in proximal relationship with said dispensing tip such that when said sample dispensing head contains a sample liquid and when said dispensing electrode is fed with said DC voltage pulse, drops of the sample liquid are caused to be dispensed through the opening in said dispensing tip onto said spatially addressed array at said selected location.

24. The electrostatic sample dispensing apparatus of claim 23 further comprising:
a counter electrode arranged opposite to said dispensing tip and having a necessary potential for electric attraction of charged drops of sample liquid dispensed through the opening in said dispensing tip.

25. The electrostatic sample dispensing apparatus of claim 24 wherein the counter electrode defines an opening through which drops of the sample liquid can be dispensed onto the spatially addressed array.

26. The electrostatic sample dispensing apparatus of claim 25 wherein the counter electrode is located between the dispensing tip and the spatially addressed array.

27. The electrostatic sample dispensing apparatus of claim 23 further comprising pressure control means for controlling the pressure of the sample liquid contained in the dispensing tip.

28. The electrostatic sample dispensing apparatus of claim 27 wherein the pressure control means comprise a sample liquid reservoir in fluid communication with the dispensing head.

29. The electrostatic sample dispensing apparatus of claim 23 further comprising:
a control system for controlling the size of said drops of the sample liquid dispensed through the opening in said dispensing tip.

30. The electrostatic sample dispensing apparatus of claim 29 wherein the size of said drops of the sample liquid dispensed through the opening in said dispensing tip is controlled by varying the size of the DC voltage pulse or the shape of the DC voltage pulse.

31. The electrostatic sample dispensing apparatus of claim 29 wherein the control system comprises computerized solid state circuitry.

32. The electrostatic sample dispensing apparatus of claim 23 wherein the spatially addressed array comprises a surface array.

33. The electrostatic sample dispensing apparatus of claim 23 wherein the spatially addressed array comprises an array of well-plates.

34. The electrostatic sample dispensing apparatus of claim 30 wherein the size of the drops dispensed at each selected location within the array is varied.

35. An electrostatic sample dispensing apparatus for dispensing a single drop of a liquid for use in an analytical process, said electrostatic sample dispensing apparatus comprising:
a voltage generator which generates a square DC voltage pulse;
a sample dispensing head comprising a dispensing tip having an opening; and
a dispensing electrode in proximal relationship with said dispensing tip.

36. The electrostatic sample dispensing apparatus of claim 35 wherein the drop of the liquid is dispensed onto a selected location within a spatially addressed array.

37. The electrostatic sample dispensing apparatus of claim 36 wherein the liquid is a biological probe.

38. The electrostatic sample dispensing apparatus of claim 36 wherein the size of said drop of the liquid dispensed through the opening in said dispensing tip at each selected location is controlled by varying the size or shape of the DC voltage pulse.

39. The electrostatic sample dispensing apparatus of claim 35 wherein said sample dispensing apparatus is controlled through an interface with a computer.

40. The electrostatic sample dispensing apparatus of claim 39 wherein the drop of the liquid is used for biochemical analysis of said drop.

41. The electrostatic sample dispensing apparatus of claim 40 wherein the biochemical analysis is carried out using a gas phase analysis technique.

42. The electrostatic sample dispensing apparatus of claim 41 wherein the gas phase analysis technique is mass spectrometry.

43. An electrostatic dispensing apparatus for dispensing a single drop of a biological probe onto a selected location within a spatially addressed array, said electrostatic sample dispensing apparatus comprising:
a voltage generator which generates a DC voltage pulse;
a sample dispensing head comprising a dispensing tip having an opening;
an XY-position control system whereby the dispensing head is manipulated to a position above the selected location within said array; and
a dispensing electrode in proximal relationship with said dispensing port such that when said sample dispensing head contains said biological probe and when said dispensing electrode is fed with said DC voltage pulse, a drop of the biological probe is caused to be dispensed through the opening in said dispensing tip onto said spatially addressed array at said selected location.

44. The electrostatic dispensing apparatus of claim 43 further comprising a drop size control system whereby the size of said drop of the biological probe dispensed through the opening in said dispensing tip at each selected location is controlled by varying the size of the DC voltage pulse or the shape of the DC voltage pulse.

45. An electrostatic dispensing apparatus for dispensing a liquid onto a substrate comprised of an insulating material, said electrostatic dispensing apparatus comprising:
a voltage generator which generates a DC voltage pulse;
a dispensing head comprising a dispensing tip having an opening; and
a dispensing electrode in proximal relationship with said dispensing tip such that when said dispensing head contains a liquid and when said dispensing electrode is fed with said DC voltage pulse, a drop of the liquid is caused to be dispensed through the opening in said dispensing tip onto said substrate.

46. The electrostatic dispensing apparatus of claim 45 further comprising a control system for controlling the size, shape or polarity of the DC voltage pulse.

47. A method for dispensing multiple drops using the apparatus of claim 34 comprising reversing the polarity of the voltage pulse after each drop of the liquid is dispensed.

48. A method of dispensing an analytical sample liquid using an electrostatic dispensing apparatus comprising a voltage generator which generates a DC voltage pulse, a dispensing head comprising a dispensing tip having an opening, a dispensing electrode in proximal relationship with said dispensing tip such that the dispensing electrode is in electrical contact with said analytical sample liquid, and a counter electrode, the method comprising:
placing said analytical sample liquid into the dispensing head;
electrically connecting said voltage generator to the dispensing electrode and the counter electrode; and
using the voltage generator to create an electrical potential difference between said analytical sample liquid and the counter electrode.

49. The method of claim 48 wherein said electrical potential difference between said analytical sample liquid and the counter electrode is at least 500 volts.

50. The method of claim 48 wherein said electrical potential difference between said analytical sample liquid and the counter electrode is at least 2000 volts.

51. The method of claim 48 wherein said electrical potential difference between said analytical sample liquid and the counter electrode is at least 4000 volts.

52. The method of claim 48 wherein said electrical potential difference between said analytical sample liquid and the counter electrode is created by applying a voltage pulse to the dispensing electrode while maintaining a voltage bias between the counter electrode and the ground.

53. The method of claim 48 wherein said electrical potential difference between said analytical sample liquid and the counter electrode is created by applying a voltage pulse to the dispensing electrode and holding the counter electrode at ground potential.

54. The method of claim 48 wherein said electrical potential difference between said analytical sample liquid and the counter electrode is created by applying a voltage pulse to the counter electrode while holding the dispensing electrode at ground potential.

55. The method of claim 48 wherein said electrical potential difference between said analytical sample liquid and the counter electrode is created by applying a voltage pulse to the dispensing electrode while maintaining an electrical potential difference between the counter electrode and the ground.
